(19) United States
(12) Patent Application Publication
(10) Pub. No.: US 2025/0180248 A1
(43) Pub. Date: Jun. 5, 2025

(54) HEATER MODULE AND BOILER

(71) Applicant: ELEMENTAL TECHNOLOGIES LTD, Worksop (GB)

(72) Inventors: Lee Cottingham, Worksop (GB); Stephen Crow, Worksop (GB); Jack Woods, Worksop (GB); Kevin Cook, Worksop (GB)

(21) Appl. No.: 18/841,020

(22) PCT Filed: Feb. 27, 2023
(86) PCT No.: PCT/EP2023/054885

§ 371 Date: Aug. 23, 2024

(30) Foreign Application Priority Data
Feb. 25, 2022 (GB) 2202670.2

(51) Int. Cl. F24H 1/10; F24H 15/174; F24H 15/32; F24H 15/37

(52) U.S. Cl. CPC F24H 1/102; F24H 15/174; F24H 15/32; F24H 15/37

(57) ABSTRACT

The present invention relates to a heater module comprising: a heat exchanger including: a first volume comprising a nano-fluid; and a second volume surrounding the first volume and in thermal communication with the first volume for a secondary fluid to circulate within, wherein the second volume comprises a secondary fluid inlet and a secondary fluid outlet; the heating module further comprising an electric heating element located within the first volume; wherein in use the electric heating element is configured to heat the nano-fluid within the first volume, and wherein the heated nano-fluid is configured to heat the secondary fluid circulating within the second volume by conduction and/or convection. The invention further includes a boiler comprising a plurality of heater modules, and a method for controlling the heating output of the boiler.

### BACKGROUND

Heating systems are used to heat a variety of environments such as domestic homes and commercial properties. One common type of heating system includes a boiler, which is used to heat a circulating fluid that is then supplied to one or more radiators disposed around a heating circuit to provide heat to the environment.

The circulating fluid in most conventional systems is water in a closed system, which may be topped up from a mains water supply. Most conventional boilers are fueled by gas which is used to heat the circulating fluid directly as it passes through the boiler, but oil-fueled and solid-fuel boilers are also well-known.

Boilers use some form of heat exchanger to heat the circulating fluid. For example, in a gas boiler, the gas is combusted and its heat is transferred to the secondary fluid which passes through a conduit formed into a serpentine path within the combustion chamber. Fins are usually provided on the conduit to enhance heat transfer.

Where heat is to be transferred from one liquid to another, the most common form of heat exchanger is a plate-fin heat exchanger which includes a plurality of layers of plates separated by fins, wherein a primary fluid and secondary fluid are contained within alternating layers of the plate-fin heat exchanger. Heat is transferred between the primary and secondary fluid as they both flow through the alternating layers of the heat exchanger.

While the use of gas-fueled boilers is commonplace, they are now not considered to be environmentally friendly due to the release of carbon dioxide gas as a combustion product. In addition, gas-fueled boilers require complex set-ups due to the need to provide a suitable gas supply and exhaust system and require frequent servicing to reduce the risk of gas leaks and/or explosions.

Electrically-powered boilers solve many of the problems above in that they do not release carbon dioxide or require complex installations to supply the necessary gas, and there are generally lower risks associated with them. However, electrically-powered boilers can be expensive to operate due to the cost of electricity and, due to typical limitations on a domestic power supply, are only capable of heating up a relatively small amount of circulating fluid at a time meaning that they are only suitable for smaller homes.

There is, therefore, a need to provide a way of heating a circulating fluid within an electrically-powered boiler in a more efficient manner in order to reduce the running cost and improve the efficiency of electrically-powered boilers.

### SUMMARY

Viewed from a first aspect, there is provided a heater module comprising: a heat exchanger including: a first volume comprising a nano-fluid; and a second volume surrounding the first volume and in thermal communication with the first volume for a secondary fluid to circulate within, wherein the second volume comprises a secondary fluid inlet and a secondary fluid outlet; the heating module further comprising an electric heating element located within the first volume; wherein in use the electric heating element is configured to heat the nano-fluid within the first volume, and wherein the heated nano-fluid is configured to heat the secondary fluid circulating within the second volume by conduction and/or convection.

The above arrangement provides a module for heating a circulating fluid using an electric heating element in a more efficient manner than conventional electrically-powered boilers.

Nano-fluids have significantly enhanced thermal conductivity than other fluids, such as water, and also have a significantly improved convective heat transfer co-efficient. Therefore, the efficiency of the transfer of heat from the electric heating element to the nano-fluid is significantly improved compared to water or other conventional fluids, and nano-fluid then efficiently transfers this heat to the circulating secondary fluid in the second volume.

The nano-fluid therefore acts as an intermediate heating medium between the electric heating element and the circulating secondary fluid, in contrast to conventional systems where the electric heating element may be used to heat the circulating fluid directly. This can result in a reduced running time of the electric heating element, leading to a better life-time efficiency of the electrically-powered boiler.

The heater module may be for use in a boiler, which may typically form part of a heating system. Specifically, the heater module may be for use in a domestic boiler, wherein the boiler may form part of a domestic heating system.

The nano-fluid may be a static fluid contained within the first volume of the heater module, wherein the first volume may be a closed volume. In this way the heater module is configured such that the nano-fluid does not circulate, other than by means of internal convection currents. As such, no pump is required to circulate it. This differs from conventional plate-fin heat exchangers where both the primary fluid and the secondary fluid are circulating through the heat exchanger. The above arrangement is advantageous as it reduces the number of pumps required in order to operate the heater module, which reduces the pumping power and energy consumption of the system as a whole.

In a preferred embodiment the heater module may be at least generally cylindrical in shape. However, alternatively, the heater module may be another convenient shape, e.g., cuboid. The heater module may comprise an outer wall, wherein the outer wall may be cylindrical in the case of the heater module being at least generally cylindrical in shape, or it may be cuboid in the case of the heater module being cuboid. The first volume may be an inner reservoir. The inner reservoir may also be cylindrical. The second volume may be in the form of a thermal jacket which may surround the first volume. The thermal jacket may form an annulus around the cylindrical inner reservoir. The thermal jacket may extend around the entirety of the inner reservoir.

The first volume and the second volume are separated, e.g., by an inner wall of the heater module. The inner wall may thus form the heat exchanger surface within the heat exchanger of the heater module. As such, the inner wall may be configured to conduct heat from the first volume and the second volume.

The secondary fluid inlet in the second volume may be connected to a source of secondary fluid. The secondary fluid outlet may be connected to a heating circuit for supplying the heated secondary fluid to a heating circuit of a heating system. Alternatively, the secondary fluid inlet may be connected to a secondary fluid outlet of a further heater module according to the first aspect such that plural modules may operate in combination. Likewise, the secondary fluid outlet may be connected to a secondary fluid inlet of a separate heater module.

The secondary fluid circulating within the second volume may comprise water, as is conventional. In this instance, the secondary fluid inlet in the second volume may be connected or connectable to a mains water supply to top up the fluid level if necessary.

Alternatively, other liquids may be used as the secondary fluid, including nano-fluids. Thus, the nano-fluid in the first volume may be a first nano-fluid, and the secondary fluid circulating within the second volume may comprise a second nano-fluid. The first nano-fluid and the second nano-fluid may have the same composition. Alternative, the first-nano-fluid and the second nano-fluid may comprise different compositions. The use of a nano-fluid on both the primary side and the secondary side of the heat exchanger may increase the efficiency of heat transfer.

The nano-fluid composition (on the primary and/or secondary side) may be adjusted depending on the intended application of the heater module. The nano-fluid may comprise nanometer-scale particles suspended in a base fluid. The nano-meter-scale particles suspended in the base fluid may form a suspension (colloidal) solution of nanometer-scale particles suspended in a base fluid.

The nanometer-scale particles may comprise one or more of metals, oxides, carbides and carbon nanotubes. In the case of the nanometer-scale particles being metal, the particles may comprise aluminum. The nano-fluid may comprise a mixture of one or more of these particle types, or it may comprise only a single particle type.

The base fluid is preferably a liquid and may comprise one or more heat transfer fluids, in particular, the base fluid may comprise one or more of water, ethylene glycol, glycerol, oil, phase change material, liquid metal or liquid alloy. The base fluid may comprise only a single fluid type, or it may comprise a mixture of fluid types. For example, the base fluid may comprise 98% glycerol and 2% water by volume.

The nanometer-scale particles may be in the range of 1-100 nm in size, optionally in the range 1-60 nm, 1-30 nm, 50-100 nm, or 50-70 nm in size. The nanometer-scale particle size may vary throughout a given nano-fluid. The concentration of the nanometer-scale particles in the based fluid may be in the range of 0.1% to 10%, optionally 0.1% to 6%, further optionally 0.1% to 2%.

The nanometer-scale particles may comprise phase-change materials, wherein they may change between solid and liquid particles as the nano-fluid is heated by the electrical heating element.

The electric heating element may be a resistive heating element whereby a current is provided to the element and a heat is emitted depending on the resistance in the well-known manner. The electric heating element is preferably fully submerged within the nano-fluid in the first volume (i.e., electric heating element may comprise an immersion heater).

The electric heating element is typically connected to an external power source, which in a preferred embodiment may be the mains supply. Alternatively, the external power source may be a battery or renewable energy sources such as solar energy or wind energy.

The heater module may comprise an opening through which the electric heating element is provided. The opening may be provided at a base of the heater module, in particular, in the case of the heater module being cylindrical the opening may be at the base of the cylinder. Alternatively, the opening may be provided at the top of the heater module, in particular, in the case of the heater module being cylindrical the opening may be at the top of the cylinder. The opening in the heater module may be provided with a seal around the immersion heater to prevent leakage of the nano-fluid from the first volume.

The electric heating element may be connected to a separate power source, wherein the power source is configured to supply a current to the electric heating element. The electric heating element may comprise a resistance and may be configured to heat up when a current is supplied to it.

The electric heating element may comprise a single element with a set resistance. Alternatively, the electric heating element may comprise a plurality of individual elements configured to modulate the supply of heat to the nano-fluid.

Each of the plurality of individual heating elements may comprise a different resistance such that they may therefore each be configured to heat the nano-fluid at a different rate.

Alternatively, each of the plurality of individual heating elements may comprise the same resistance and a different current may be supplied to each element in use such that each of the plurality of individual heating elements may be configured to heat the nano-fluid at a different rate. Each of the plurality of individual electrical elements may be connected to a single power source. Alternatively, each of the plurality of individual electrical elements may be connected to a separate power source.

The heater module may comprise a temperature sensor. The heater module may comprise a first orifice to provide access to the first volume for a temperature sensor fitted into it. The temperature sensor may therefore be configured to measure the temperature of the nano-fluid within the first volume. The temperature sensor may be immersed in the nano-fluid and may be immersed up to 40 mm in length. The temperature sensor may be configured to measure up to a temperature of 300° C.

In use, the electric heating element may be configured to heat the nano-fluid up to a temperature higher than a desired temperature of the circulating secondary fluid. For example, the electric heating element may be configured to heat the nano-fluid to a temperature of 300° C. or less, optionally to a temperature of 250° C., optionally to a temperature of 230° C. or less, optionally to a temperature of 150° C. or less, optionally to a temperature of 70° C. or less.

Additionally or alternatively, in order to modulate the heat output of the module, the electric heating element may be controlled to heat the nano-fluid to different temperatures. Thus, compared to the module's normal heat output (say 2 kW), the nano-fluid may be heated to a lower temperature in order to provide a lower heat output to the secondary fluid (say 1 kW). This may be achieved by cycling the element so that it provides heat for a shorter proportion of the time. This is in contrast with the usual arrangement whereby the heating element will be arranged to maintain the nano-fluid temperature as differing amounts of heat are demanded by the secondary fluid.

The present invention is particularly applicable to heating systems, such as domestic central heating, and so the circulating fluid will typically be supplied to the heating circuit at a temperature below 80° C., and more usually below 75° C. or 70° C. Accordingly, the temperature will typically be at least 40° C. Therefore, the circulating fluid may be supplied to the heating circuit at a temperature in the range of 40° C. to 80° C. Preferably, in a normal mode of operation the temperature of the circulating fluid may be in a range of 55° C. to 80° C., more preferably in a range of 60° C. to 80° C., 65° C. to 75° C., 60° C. to 70° C., 55° C. to 70° C., or 55° C. to 65° C.

In addition to the normal mode of operation, the heater module may have a low temperature hot water (LTHW) mode of operation, and so the temperature of the circulating fluid may be in the range 45° C. to 55° C., preferably in the range of 45° C. to 50° C. or 50° C. to 55° C. Therefore, by efficiently heating the nano-fluid up to, for example, 250° C., the electric heating element can be switched off and the heated nano-fluid can transfer its heat to the circulating secondary fluid in the second volume as required.

The heater module, or a boiler of which it forms part, may further comprise a control system. The control system may control the operation of the electric heating element. The control system may be configured to receive the temperature of the nano-fluid from the temperature sensor. The control system may be configured to control the electric heating element to maintain the nano-fluid in a pre-defined temperature range. The pre-defined temperature range may comprise a minimum temperature and a maximum temperature.

The electric heating element may be configured to heat the nano-fluid to the maximum temperature. In use, when the temperature sensor detects that the nano-fluid has reached the maximum temperature, the control system may be configured to deactivate the electric heating element. As the heat in the nano-fluid is transferred to the circulating secondary fluid, the temperature of the nano-fluid will decrease. The control system may be configured to activate the electric heating element when the temperature sensor detects that the temperature of the nano-fluid is at or below the minimum temperature.

The above arrangement allows the temperature of the nano-fluid to be controlled between a minimum and maximum temperature which are set to ensure that the circulating secondary fluid is maintained at the desired temperature. In conventional systems the temperature sensors may be on the secondary fluid side of the circuit, and the electric heating elements may be active until the secondary fluid is at the desired temperature. However, in the present aspect, there will be a certain amount of thermal lag due to the heat transfer taking place between the nano-fluid and the secondary fluid. Therefore, by deactivating the electric heating elements once the nano-fluid is at a temperature known to provide sufficient heat to the secondary fluid, the time that the electric heating element is active is reduced further compared to a system where it would be active until the secondary fluid is at the desired temperature. This may reduce energy usage of the electrically-powered boiler as there would be longer periods where the electric heating element is not active due to the use of a nano-fluid as an intermediate heating medium. Additionally, the efficiency of the heat transfer from the electric heating element to the nano-fluid when it is active is increased, meaning that the electric heating element can be deactivated sooner compared to when using conventional fluid types.

To accommodate thermal expansion of the nano-fluid, the first volume of the heater module may be provided with internal headspace and/or an external expansion vessel.

The heater module may comprise a pressure sensor. The heater module may comprise a second orifice to provide access to the first volume for the pressure sensor. The pressure sensor may be configured to detect the pressure of the nano-fluid within the first volume and it may detect a reduction or increase in pressure. The control system may be configured to compare the pressure detected by the pressure of the nano-fluid in the first volume with the expected pressure at the current temperature detected by the temperature sensor.

This may allow the system to monitor for any leaks of the nano-fluid in the first volume which may prevent a reduction in heating efficiency or mixing of the nano-fluid and the secondary fluid. The pressure sensor may therefore be configured to operate as a leak detection system.

In addition, the above arrangement may allow the system to monitor for any significant increases in pressure of the nano-fluid in the first volume. Excessive increases in pressure within the nano-fluid may cause damage to the components of the heater module and the wider heating system as a whole. The control system may be configured to issue an alert in the case of the pressure in the first volume reaching a threshold pressure. The threshold pressure may be determined based on the material properties of the heater module, more specifically the first volume. The alert may preferably be an audible alert, but could also be a visual alert, or both an audible and visual alert together.

The heater module may comprise a pressure relief valve. The heater module may comprise a third orifice for the pressure relief valve. The pressure relief valve may be connected to blow-off valve and a pressure tank. The control system may be configured to compare the pressure of the nano-fluid within the first volume to a maximum allowable pressure of the first volume. The maximum allowable pressure may be determined by the material properties of the heater module as a whole, or more specifically it may be determined by the material properties of the inner wall between the first volume and the second volume. For example, the maximum allowable pressure within the first volume may be 3 bar. In this instance, the pressure sensor may be capable of measuring pressures up to 4 bar.

In operation, if the pressure detected is at or near the maximum allowable pressure, the control system may be configured to open the pressure relief valve. This arrangement allows for excess thermal expansion of the nano-fluid.

Alternatively, in response to a significant increase in pressure detected, or when the pressure is at or near the maximum allowable pressure, the control system may issue an alert. The alert may identify the heater module where the pressure threshold has been reached. The control system may be configured to then remove substantially all of the nano-fluid within the first volume of the heater module and the alert may indicate replacement required. The alert may indicate that maintenance of the boiler and/or heater module is required.

The invention also extends to a corresponding method of operation, accordingly, viewed from a second aspect, there is provided a method of heating a circulating secondary fluid using a heater module, the heater module comprising: a heat exchanger including: a first volume comprising a nano-fluid; and a second volume surrounding the first volume and in thermal communication with the first volume for a circulating fluid to circulate within, wherein the second volume comprises a secondary fluid inlet and a secondary fluid outlet; and the heating modules further comprising an electric heating element located within the first volume; the method comprising: heating the nano-fluid within the first volume using the electric heating element; and circulating the secondary fluid within the second volume such that the heat from the nano-fluid is conducted to the secondary fluid.

The method provided by the second aspect of the present invention may include any of the features discussed in connection with the first aspect above. In particular, the secondary fluid may comprise water. Alternatively, the nano-fluid in the first volume may be a first nano-fluid, and the secondary fluid may comprise a second nano-fluid. The first and second nano-fluid may comprise the same composition, or a different composition.

The nano-fluid within the first volume may be static during the heating process, wherein only the secondary fluid is circulating.

The method may comprise monitoring the temperature of the nano-fluid in the first volume using a temperature sensor.

The method may comprise heating the nano-fluid to a temperature of 300° C. or less, optionally to a temperature of 250° C. or less, optionally to a temperature of 230° C. or less, optionally to a temperature of 150° C. or less, further optionally up to a temperature of 70° C. or less.

The method may comprise maintaining the temperature of the nano-fluid within a pre-defined temperature range using the electric heating element. The pre-defined temperature range may be between a minimum temperature and a maximum temperature.

The method may comprise heating the nano-fluid within the second volume using the electric heating element to the maximum temperature. The method may comprise deactivating the electric heating element once the temperature of the nano-fluid has reached the maximum temperature. As the heat from the nano-fluid is transferred to the secondary fluid, the temperature of the nano-fluid may gradually decrease. The method may comprise activating the electric heating element when the temperature of the nano-fluid reaches the minimum temperature.

The method may comprise monitoring the pressure of the nano-fluid within the first volume. The method may comprise comparing the pressure of the nano-fluid in the first volume to an expected pressure at the current temperature of the nano-fluid. The method may comprise comparing the pressure of the nano-fluid within the first volume to a maximum allowable pressure in the first volume. The method may comprise opening a pressure relief valve to release a portion of the nano-fluid from the first volume.

In each of the first and second aspects, the use of a nano-fluid on both the primary side (the first volume) and the secondary side (second volume) of the heat exchanger has been discussed in connection with the specific arrangement of the heater module as a whole. It will be appreciated that a further, third, aspect of the present invention provides a heat exchanger operating with a first nano-fluid as a primary fluid, and a second nano-fluid as a secondary fluid. The heat exchanger of the third aspect may be any form of heat exchanger and it may be used in a heating system in which the secondary fluid is supplied to radiators or other emitters. The use of a nano-fluid to heat a second nano-fluid may improve heat transfer.

According to a first species of the third aspect above, the present invention also provides a heat exchanger comprising a first nano-fluid configured to operate as a primary fluid, and a second nano-fluid configured to operate as a secondary circulating fluid, wherein the secondary circulating fluid is configured to be supplied to a heating circuit of a heating system.

The first nano-fluid may be a stationary fluid.

The heat exchanger according to the third aspect may comprise any of the features discussed in relation to the first and second aspects above. The first and second nano-fluids may be the same type of nano-fluid, or alternatively they may be different types of nano-fluid. The specific nano-fluid used as the primary and secondary fluids in the heat exchanger may depend on the desired heating output of the heat exchanger.

As discussed above, a plurality of heater modules of the invention may be used in combination within a boiler. Accordingly, viewed from a fourth aspect, there is provided a boiler for use in a heating system comprising: one or more heater modules, wherein each heater module comprises: a heat exchanger including: a first volume comprising a nano-fluid; and a second volume surrounding the first volume and in thermal communication with the first volume for a secondary fluid to circulate within, wherein the second volume comprises a secondary fluid inlet and a secondary fluid outlet; and the heater module further comprising an electric heating element located within the first volume; wherein in use the electric heating element is configured to heat the nano-fluid within the first volume, and wherein the heated nano-fluid is configured to heat the secondary fluid circulating within the second volume by conduction and/or convection.

Each of the one or more heater modules defined in the fourth aspect may comprise any of the features discussed in connection with the first, second and/or third aspect above.

In a preferred embodiment the boiler may comprise a plurality of heater modules, and the boiler may comprise a controller configured to set a heating output of the boiler by selecting one or more of the plurality of heater modules to heat the circulating secondary fluid.

In the above arrangement the nano-fluid is divided across a plurality of heater modules and so the volume of each first volume is smaller than if the same amount of nano-fluid is contained within a single heater module. As each heater module comprises a smaller volume of nano-fluid, for a given output power, the time required by the electric heater element to heat the nano-fluid to the required temperature is less than if all the nano-fluid was contained within a single, larger, reservoir. Furthermore, the overall surface area for heat transfer between the nano-fluid in the first volume and the circulating secondary fluid in the second volume is increased.

Moreover, the above boiler arrangement means that the heating output of the boiler can be adjusted dependent on the demand of a heating system to which the boiler is connected.

The secondary fluid may comprise water. Alternatively, the nano-fluid may be a first nano-fluid and the secondary fluid may be a second nano-fluid. The first nano-fluid and the second nano-fluid may comprise different compositions. Alternatively, the first nano-fluid and the second nano-fluid may comprise the same composition.

Each of the plurality of heater modules may be connected to each other in series. In this instance, the plurality of heater modules may comprise a first end heater module, a second end heater module, and optionally one or more intermediate heater modules. The secondary fluid inlet of the first end heater module may be fluidly connected to a source of secondary fluid. The secondary fluid outlet of the second end heater module may be fluidly connected to a heating circuit. The secondary fluid outlet of each of the one or more intermediate heater modules (if provided) may be fluidly connected to the second fluid inlet of either another of the one or more intermediate heater modules or the second end heater module.

In the above arrangement, the boiler may be configured such that the secondary fluid is transferred from each of the plurality of heater modules in series. Each of the plurality of heater modules may therefore be configured to heat the secondary fluid by a set amount. This advantageously provides a greater contact time between the nano-fluid and the secondary fluid to increase the heat transfer between the two. This allows the secondary fluid to be heated to a higher temperature for a given amount of heat supplied to each nano-fluid compared to the secondary fluid temperature if only a single heater module were present.

The electric heating element within each of the plurality of heater modules may be configured to heat the nano-fluid in each heater module to the same temperature.

Alternatively, the electric heating element within each of the plurality of heater modules may be configured to heat the nano-fluid in each of the heater modules to a different temperature. For example, the electric heating element of the first end heater module may be configured to heat the nano-fluid to a first temperature, and the electric heating element of the second end heater module may be configured to heat the nano-fluid to a second temperature, wherein the second temperature may be higher than the first temperature. The electric heating elements in each of the one or more intermediate heater modules may be configured to heat the respective nano-fluid to an intermediate temperature between the first temperature and the second temperature. The intermediate temperature of each of the one or more intermediate temperatures may increase from the first temperature to the second temperature in each subsequent intermediate heater module of the one or more intermediate heater modules. The increase from the first temperature sensor may be linear.

In an alternative arrangement, each of the plurality of heater modules may be connected in parallel. The secondary fluid inlet of each of the plurality of heater modules is fluidly connected to a source of the secondary fluid. The secondary fluid outlet of each of the plurality of heater modules may be connected to a heating circuit such that heated secondary fluid may be supplied to the heating circuit.

The boiler may comprise an inlet manifold. The inlet manifold may be fluidly connected to the source of secondary fluid. The secondary fluid inlet of each of the plurality of heater modules may be connected to the inlet manifold in order to receive the secondary fluid.

The boiler may comprise an outlet manifold. The outlet manifold may be fluidly connected to the heating circuit. The secondary fluid outlet of each of the plurality of heater modules may be connected to the outlet manifold. The outlet manifold may therefore be configured to supply the heating circuit with heated secondary fluid.

In contrast to the arrangement where the plurality of heater modules is connected in series, in the above arrangement, the boiler is configured such that the secondary fluid circulates within the second volume of each of the plurality of heater modules in parallel. The heated secondary fluid is then transferred directly to the heating circuit, instead of to an adjacent heater module for further heating.

The heating output of the boiler may be set based on the heating demand of the boiler, which in turn may be defined by the heating circuit and/or a use of the boiler.

The controller may be configured to set a heating output of the boiler by selecting the number of heater modules where the electric heating element is activated. In particular, the controller may be configured to activate the electric heating element in each of the plurality of heater modules. In this instance the boiler would be operating at 100% capacity. Alternatively, the controller may be configured to activate the electric heating element in a portion of the plurality of heater modules. For example, the controller may be configured to activate the electric heating element in 75% of the plurality of heater modules, optionally 50% optionally 25%, optionally 10%. In these instances, the boiler would be operating at 75%, 50%, 25% and 10% of its total capacity respectively.

In this mode, the nano-fluid will only be heated in the heater modules where the electric heating element is activated. Therefore, the secondary fluid circulating through the plurality of heater modules will only be heated in heater modules where the electric heating element is activated. This allows the controller to effectively reduce the amount of heat transferred to the secondary fluid within the boiler.

In addition, or as an alternative, the controller may be configured to set a heating output of the boiler by controlling a current supplied to the electric heating element in each of the plurality of heater modules. For example, the controller may be configured to supply a lower power to one or more of the electric heater elements so the respective nano-fluid is heater to a lower temperature than the nano-fluid in the other heater modules. In this instance, less heat will be transferred to the secondary fluid as it circulates through the heater module comprising the electric heating element with the lower power supply.

The boiler may further comprise one or more valves configured to control the flow of the secondary fluid between the plurality of heater modules. The controller may be configured to set a heating output of the boiler by controlling the one or more valves to prevent flow of secondary fluid to one or more of the plurality of heater modules.

In the case of the plurality of heater modules being connected in series, each of the valves may be positioned directly at the inlet of each of the plurality of heater modules. The boiler may further comprise a bypass line. Each of the valves may be a three-way valve. Each valve may be controllable to allow flow of the secondary fluid into the heater module via the secondary fluid inlet, or each valve may be controllable to divert flow to the bypass line. In the case of the flow being diverted to the bypass line, the secondary fluid may circulate in the heater module directly after the respective valve.

In use, the controller may be configured to set the heating output of the boiler by controlling the direction of the secondary fluid through each of the one or more valves. In particular, the controller may be configured to bypass one or more of the plurality of heater modules by using the one or more valves at the secondary fluid inlets of the one or more heater modules to divert the secondary fluid to the bypass line. In the case of series-connected modules, bypassing one or more of the plurality of heater modules has the effect of reducing the contact time between the circulating secondary fluid and the nano-fluid, therefore resulting in less heat being transferred to the secondary fluid.

The above arrangement allows the controller to effectively adjust the heating output. For example, in the case where all of the one or more valves are configured to allow flow of secondary fluid to the respective heater module, the boiler would be operating at 100% of its total capacity. Alternatively, if the one or more valves were configured to divert flow to the bypass line to bypass 75%, 50% or 25% of the plurality of heater modules, the boiler would be operating at 25%, 50% or 75% of its total capacity respectively.

In the case of the plurality of heater modules being connected in parallel, each of the one or more valves may be positioned at the secondary fluid inlet of each of the plurality of heater modules. Each of the one or more valves may be positioned between the inlet manifold and the inlet on each of the plurality of heater modules. Each of the one or more valves may be a two-way valve. Each of the one more valves may be controllable to allow flow of the secondary fluid to the heater module via the secondary fluid inlet, or prevent flow of the secondary fluid to the heater module.

In use, the controller may be configured to set the heating output of the boiler by controlling the flow of secondary fluid through the one or more valves. In particular, the controller may control the valves to prevent flow of secondary fluid to one or more of the plurality of heater modules. The secondary fluid may then only flow to the one or more heater modules where the valves allow flow of secondary fluid.

The above arrangement means that the secondary fluid may only be heated in the heater modules to which the one or more valves allow flow. For example, if the one or more valves are controlled to allow flow to all of the plurality of heater modules, the boiler would be operating at 100% of its total capacity. Alternatively, if the one more valves were controlled such that 75%, 50% or 25% of the valves prevented flow to the respective heater module, the boiler would be operating at 75%, 50% or 25% capacity respectively.

The controller may be configured to determine the heating output based on the heating demand of the boiler. The heating system may comprise a supply temperature sensor configured to measure the supply temperature, which may be temperature of the secondary fluid being supplied to the heating circuit. The heating system may comprise a return temperature sensor configured to measure the return temperature, which may be the temperature of the secondary fluid being returned to the boiler. The heating system may further comprise a flow sensor configured to determine the flow rate of the secondary fluid being supplied to the heating circuit.

The controller may be configured to determine the heating demand of the boiler by calculating a temperature drop between the supply temperature and the return temperature. The temperature drop may be determined by one or more of a user temperature set point for the heating system and the heating capacity of one or more radiators on the heating circuit. The controller may be configured to determine the heating demand for the boiler based on the temperature drop and the flow rate of the fluid being supplied to the heating circuit.

The use of a plurality of heater modules within a boiler and the controller configured to set the heating output by selecting one or more of the heater modules to heat the circulating fluid has been described above provides a still further aspect of the invention.

Accordingly, viewed from a fifth aspect, there is provided a boiler for use in a heating system comprising: a plurality of heater modules, wherein each heater module comprises: a heat exchanger including: a first volume comprising a nano-fluid; and a second volume surrounding the first volume and in thermal communication with the first volume for a secondary fluid to circulate within, wherein the second volume comprises a secondary fluid inlet and a secondary fluid outlet; and the heater module further comprising an electric heating element located within the first volume; wherein in use the electric heating element is configured to heat the nano-fluid within the first volume, and wherein the heated nano-fluid is configured to heat the secondary fluid circulating within the second volume by conduction and/or convection; wherein the boiler comprises a controller configured to set a heating output of the boiler by selecting one or more of the plurality of heater modules to heat the circulating secondary fluid.

The fifth aspect above may include any of the features discussed in accordance with the preceding aspects of the invention.

In addition, viewed form a sixth aspect of the present invention, there is provided a method of controlling the heating output of a boiler for use in a heating system, the boiler comprising: a plurality of heater modules, wherein each heater module comprises: a heat exchanger including: a first volume comprising a nano-fluid; and a second volume surrounding the first volume and in thermal communication with the first volume for a secondary fluid to circulate within, wherein the second volume comprises a secondary fluid inlet and a secondary fluid outlet; and the heater modules further comprising an electric heating element located within the first volume; wherein in use the electric heating element is configured to heat the nano-fluid within the first volume, and wherein the heated nano-fluid is configured to heat the secondary fluid circulating within the second volume by conduction and/or convection; wherein the method comprises setting, with a controller, a heating output of the boiler by selecting one or more of the plurality of heater modules to heat the circulating secondary fluid.

The sixth aspect above may include any of the features discussed in relation to any one of the first to fifth aspects above.

In particular, the method may comprise setting the heating output based on the heating demand of the boiler, which in turn may be defined by the heating circuit and/or a use of the boiler.

The method may comprise setting the heating output of the boiler by setting the number of heater modules where the electric heating element is activated. In particular, the method may comprise activating the electric heating element in each of the plurality of heater modules. In this instance the boiler would be operating at 100% capacity. Alternatively, the method may comprise activating the electric heating element in a portion of the plurality of heater modules. For example, method may comprise activating the electric heating element in 75% of the plurality of heater modules, optionally 50% optionally 25%, optionally 10%. In these instances, the boiler would be operating at 75%, 50%, 25% and 10% of its total capacity respectively.

In addition, or as an alternative, the method may comprise setting set a heating output of the boiler by controlling the power supplied to the electric heating element in each of the plurality of heater modules. For example, the method may comprise supplying a lower power to one or more of the electric heater elements so the respective nano-fluid is heater to a lower temperature than the nano-fluid in the other heater modules.

The boiler may further comprise one or more valves configured to control the flow of the secondary fluid between the plurality of heater modules.

The method may comprise setting the heating output of the boiler by controlling the flow of the secondary fluid through each of the one or more valves. In the case of the plurality of heater modules being connected in series, the boiler may further comprise a bypass line. Each of the valves may be a three-way valve. Each valve may be controllable to allow flow of the secondary fluid into the heater module via the secondary fluid inlet, or each valve may be controllable to divert flow to the bypass line. The method may comprise controlling one or more of the valves to divert the flow of secondary fluid to a bypass line in order to bypass one or more of the plurality of heater modules.

In the case of the plurality of heater modules being connected in parallel, each of the one or more valves may be positioned at the secondary fluid inlet of each of the plurality of heater modules. Each of the one or more valves may be positioned between the inlet manifold and the inlet on each of the plurality of heater modules. Each of the one or more valves may be a two-way valve. Each of the one more valves may be controllable to allow flow of the secondary fluid to the heater module via the secondary fluid inlet, or prevent flow of the secondary fluid to the heater module.

The method may comprise setting the heating output of the boiler by controlling the flow of secondary fluid through the one or more valves. The method may comprise preventing prevent flow of secondary fluid to one or more of the plurality of heater modules.

Each of the fourth, fifth and sixth aspects above have been described in relation to the first volume comprising a nano-fluid and the second volume comprising a secondary fluid, which may be either water or a second nano-fluid of a different or same composition as the nano-fluid within the first volume. However, it will be appreciated that the boiler arrangement and methods for setting the heating outputs described above may be applicable to, for example, a domestic boiler regardless of whether the heater modules are as discussed above.

Therefore, viewed from a seventh aspect of the present invention, there is provided a domestic boiler for use in a domestic heating system comprising: a plurality of heater modules configured to heat a circulating fluid; wherein the boiler comprises a controller configured to set a heating output of the boiler by selecting one or more of the plurality of heater modules to heat the circulating fluid.

Similarly, viewed from an eighth aspect, there is provided a method of controlling the heating output of a domestic boiler for use in a domestic heating system, the boiler comprising: a plurality of heater modules configured to heat a circulating secondary fluid; wherein the method comprises setting, with a controller, a heating output of the boiler by selecting one or more of the plurality of heater modules to heat the circulating fluid.

Both of the seventh and eighth aspects may include any of the features discussed in connection with the fourth, fifth and sixth aspects discussed above, wherein the secondary fluid of the preceding aspects forms the circulating fluid referred to in the seventh and eighth aspects. In addition, the circulating fluid may be heated directly by an electric heating element. Alternatively, the circulating fluid may be heated directly by combustion of a fuel, such as gas, oil, wood or coal. Optionally, as in the preceding aspects, the heater module may comprise a heat exchanger as above wherein the circulating fluid may be heated by an intermediate primary fluid, such as a nano-fluid.

In addition, it will also be appreciated that the heat exchanger discussed in the third aspect above, including the first species of the third aspect, whereby the primary fluid comprises a first nano-fluid and the secondary fluid comprises a second nano-fluid, may be applicable to the boiler arrangements discussed in the fourth, fifth and sixth aspects. Accordingly, viewed from a ninth aspect, there is provided a boiler for use in a heating system comprising one or more heater modules, wherein each heater module comprises a heat exchanger as discussed in the third aspect above. The second nano-fluid may be configured to operate as the circulating fluid within the boiler, and the second nano-fluid may be configured to be output to a heating circuit of a heating system.

The boiler according to the ninth aspect may comprise any of the features discussed in relation to the fourth, fifth and sixth aspects above.

Moreover, the plurality of heater modules may be connected in series or parallel. Preferably, the boiler is connected to a source of the secondary fluid and to a heating circuit.

In each of the aspects discussed above, the one or more heater modules may be arranged in a vertical orientation. In other words, the one or more heater modules may be arranged such that a central axis of the first volume is at least substantially vertical in use. In the case of the aspects concerning a boiler, each of the one or more heater modules may be orientated such that the central axis of the first volume is vertical with respect to the orientation of the boiler in use.

Alternatively, in each of the aspects discussed above, the one or more heater modules may be arranged in an at least substantially horizontal orientation in use. In other words, the one or more heater modules may be arranged such that a central axis of the first volume is horizontal. In the case of the aspects concerning a boiler, each of the one or more heater modules may be orientated such that the central axis of the first volume is horizontal with respect to the orientation of the boiler in use.

### BRIEF DESCRIPTION OF THE DRAWINGS

Certain embodiments of the invention will now be described, by way of example only, with reference to the accompanying drawings, in which:

FIG. 1 shows a perspective view of a heater module;

FIG. 2 shows a cross-section of the heater module;

FIG. 3 shows a perspective view of the base of the heater module;

FIG. 4 shows a schematic of a heating system comprising a single heater module in a vertical orientation;

FIG. 5 shows a schematic of a heating system comprising a plurality of heater modules in a vertical orientation connected in series;

FIG. 6 shows a schematic of an alternative arrangement of a heating system comprising a plurality of heater modules in a vertical orientation connected in series;

FIG. 7 shows a schematic of a heating system comprising a plurality of heater modules in a vertical orientation connected in parallel; and

FIG. 8 shows a schematic of a heating system comprising a single heater module in a horizontal orientation;

FIG. 9 shows a schematic of a heating system comprising a plurality of heater modules in a horizontal orientation connected in series;

FIG. 10 shows a schematic of an alternative arrangement of a heating system comprising a plurality of heater modules in a horizontal orientation connected in series;

FIG. 11 shows a schematic of a heating system comprising a plurality of heater modules in a horizontal orientation connected in parallel.

### DETAILED DESCRIPTION

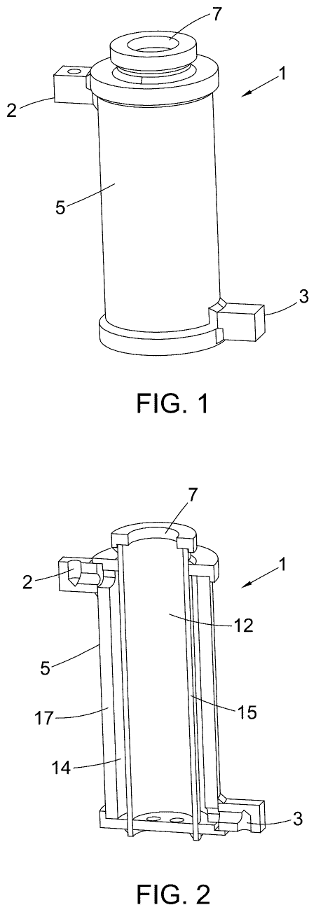

FIG. 1 depicts a heater module 1 comprising a cylindrical tank 5 including an inlet 2 proximate the top of the tank 5 and an outlet 3 proximate the base of the tank 5. The heater module 1 further comprises an immersion heater (not shown) which is inserted via an access point 7.

FIG. 2 shows a cross section of the heater module 1 of FIG. 1. The tank 5 comprises a heat exchanger including a cylindrical inner reservoir 12 surrounded by an annular volume forming thermal jacket 14. The inner reservoir 12 and the thermal jacket 14 are separated by a cylindrical inner wall 15 and are in thermal communication with each other. The immersion heater (not shown) extends from access point 7 into the inner reservoir 12.

The inner reservoir 12 is contained within the inner wall 15 and the thermal jacket 14 is contained within the annulus formed between the inner wall 15 and an outer jacket 17, wherein the outer jacket 17 forms the outer surface of the tank 5.

In use, the inner reservoir 12 contains a static primary fluid which is heated by the immersion heater (not shown) inserted through the access point 7 so that it is in contact with the primary fluid. In the present embodiment, the primary fluid is a nano-fluid. The immersion heater may include a resistive electrical element which is connected to an external power source.

Typically, only a single immersion heater may be inserted through the access point 7 to heat the nano-fluid within the inner reservoir 12, however it will be appreciated that a plurality of immersion heaters may be used to heat the nano-fluid. In particular, immersion heaters capable of delivering different power outputs may be used in order to modulate the power supplied to the nano-fluid.

The nano-fluid within the inner reservoir 12 comprises a base fluid with nanometer-scale particles suspended within the base fluid. The nanometer-scale particles are in the range of 1-100 nm in size and may be one of metals, oxides, carbides or carbon nanotubes and the base fluid may comprise one of heat transfer fluids, metal based base fluid, water, ethylene glycol, glycerol or oil. The concentration of nano-particles may be in the range of 0.1-10%. In the present embodiment, the nano-fluid comprises aluminum nanoparticles at a concentration of 1.48% suspended in a base fluid comprising glycerol and water, wherein the glycerol forms 98% of the base fluid and the remaining 2% is water. The size of the aluminum nanoparticles varies within the nano-fluid.

During use of the heater module 1, in this case, the immersion heater heats the nano-fluid up to a temperature of 250° C. The temperature to which the nano-fluid is heated by the immersion heater depends on the composition of the nano-fluid and the type of electrical element used to form the immersion heater and can be adjusted accordingly depending on the application. A secondary fluid enters the heater module 1 at the inlet 2 and surrounds the inner reservoir 12 within the thermal jacket 14. The heat stored within the nano-fluid in the inner reservoir 12 transferred to the secondary fluid through conduction and/or convection via the cylindrical inner wall 15. It will be appreciated that both the nano-fluid in the inner reservoir 12 and the secondary fluid within the thermal jacket 14 are in contact with the inner wall 15, thereby allowing the conduction and/or convection of heat between the two fluids to take place. The heated secondary fluid then exits the heater module 1 via outlet 3.

In use, the secondary fluid is the only fluid which is flowing through the heater module 1 as the nano-fluid (primary fluid) remains static within the inner reservoir 12. The secondary fluid may be either water or a second nano-fluid or any other type of suitable heat transfer fluid so that the nano-fluid within the inner reservoir 12 may be used to heat either water, another nano-fluid, or alternative heat transfer fluid types.

Any such second nano-fluid may comprise the same composition as the nano-fluid within the inner reservoir 12, or it may comprise a different composition depending on the temperature, viscosity and stability requirements of the secondary fluid.

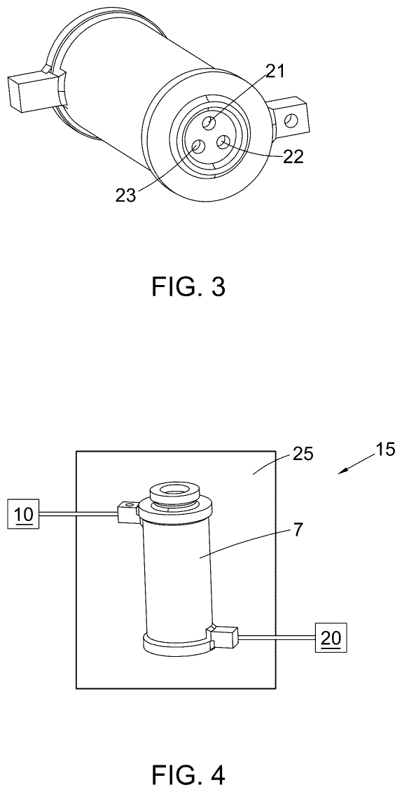

FIG. 3 shows a view of the base of the heater module 1 which includes three orifices 21, 22, 23. A first orifice 21 is to allow a temperature sensor to be inserted into the nano-fluid to monitor the temperature of the nano-fluid as it undergoes heating by the immersion heater. The temperature sensor is immersed in the nano-fluid via the first orifice 21 by up to approximately 40 mm in length.

A second orifice 22 is to allow a pressure sensor to be connected to the heater module 1. A syphon is inserted into the nano-fluid through the second orifice 22 to allow a remote pressure sensor to monitor the pressure of the nano-fluid as it undergoes heating by the immersion heater. The pressure sensor is also able to detect low pressure and a reduction in pressure which may be indicative of a leak. In this case, the pressure sensor may act as a leak detection system by comparing the detected pressure of the nano-fluid against the expected pressure of the nano-fluid at a given temperature.

A third orifice 23 is to allow for a pressure relief valve to be connected to the inner reservoir 12, with additional blow-off pipework to direct fluid into a pressure tank in the instance of high pressure. The pressure relief valve comprises a spring mechanism configured to relieve pressure in the system once the pressure is above a maximum allowable pressure on the inner wall. The maximum pressure allowable in the heater module 1 of the present embodiment is 3 bar. Similarly, the spring mechanism of the pressure relief valve is sized accordingly to open once the pressure within the inner reservoir 12 is above 3 bar. The pressure sensor would therefore be selected accordingly in order to measure at least up to 3 bar. Similarly, in the present embodiment, the nano-fluid is heated up to 250° C. and so the temperature sensor would be capable of measuring at least up to 250° C.

In operation the temperature of the nano-fluid is monitored by the temperature sensor in order to maintain the temperature in a predetermined range between a minimum temperature and a maximum temperature. The immersion heater heats the nano-fluid up to the predetermined maximum temperature, at which point the immersion heater is deactivated. The temperature of the nano-fluid will then increase slightly due to thermal run-off, but then gradually reduce as heat is conducted to the secondary fluid circulating through the thermal jacket 14 around the nano-fluid in the inner reservoir 12. Once the temperature sensor detects that the temperature of the nano-fluid has fallen below the predetermined minimum temperature, the immersion heater is reactivated and the nano-fluid is heated back up to the predetermined maximum heater module.

FIG. 4 depicts schematically a heating system 15 comprising a boiler 25, a source/return supply of secondary fluid 10 and heating circuit 20. The boiler comprises a single heater module 7 as described in relation to FIGS. 1 to 3.

The heating circuit 20 includes a looped filling system comprising a pump to recirculate the secondary fluid from the heating circuit to the return supply of secondary fluid 10 for it to then re-enter the heating module 1. Hence, the secondary fluid is contained within a closed circuit including the source of secondary fluid 10, the thermal jacket 14 and the heating circuit 20.

The secondary fluid circuit further comprises a pressure relief valve, blow off valve and drain off point, each of which are in communication with temperature and pressure systems throughout the secondary fluid circuit. The secondary fluid circuit further comprises an auxiliary secondary fluid source to be used to provide additional secondary fluid if required.

The heating circuit comprises a series of radiators that are used to heat areas within a building which may be domestic, commercial or industrial in nature. In use, the secondary fluid is pumped from the secondary fluid source 10 through the inlet 2 into the thermal jacket 14 which surrounds the inner reservoir 12.

The nano-fluid in the inner reservoir 1 is heated using the immersion heater to a high temperature so that the nano-fluid heats the secondary fluid in the thermal jacket 14.

The heated secondary fluid is then pumped from the thermal jacket 14 to the heating circuit 20 through the outlet 3. The heated secondary fluid flows through the one or more radiators on the heating circuit 20. In the case of the secondary fluid being a second nano-fluid, the heated secondary fluid in the heating circuit 20 is then re-circulated back to the secondary fluid source 10 to be re-heated in the heater module 1.

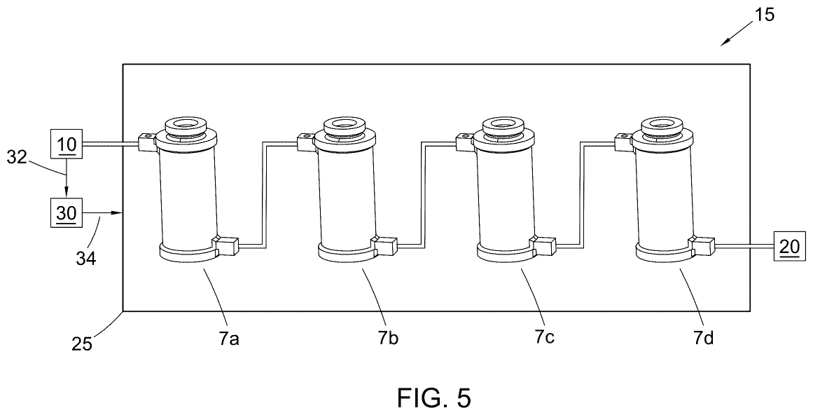

FIG. 5 depicts a further embodiment of a heating system 15 comprising a boiler 25, a source of secondary fluid 10 and a heating circuit 20. In this embodiment the boiler 25 comprises four heater modules 7a-d as described in, relation to FIGS. 1 to 3, connected in series, wherein the outlet 3 of a first heater module 7a is connected to the inlet 2 of a second heater module 7b and so on until the outlet 3 of the fourth heater module 7d is connected to the heating circuit 20. It will be appreciated that any number of heater modules 7 may be connected in series within the boiler 25 depending on the size constraints and demand requirements of the heating system 15.

In operation, the source of secondary fluid 10 supplies the first heater module 7a via the inlet 2 on the first heater module 7a. Each of the heater modules 7a-d comprise an individual immersion heater, or multiple electrical elements to modulate the heating supply, to heat the static nano-fluid within the inner reservoirs 12 of each heater module 7a-d. As the secondary fluid enters the first heater module 7a and surrounds the nano-fluid within the thermal jacket 14 it is heated by the nano-fluid. The heated secondary fluid is then transferred from the first heater module 7a to the second heater module 7b in order to further heat the secondary fluid and the process is repeated for each of the second, third and fourth heater module 7b-d.

The heating system 15 further comprises a control system 30 which is used to modulate the number of heater modules 1 in operation. The number of heater modules 1 in operation set by the control system 30 is determined by a heating demand for the boiler 25. In cases where the demand on the heating system is high, all four heat exchanges 7a-d are in operation with the immersion heater heating the nano-fluid to heat the secondary fluid flowing through each heater module 7a-d.

If there is a reduction in demand for the heating system 15 one or more of the heater modules 7a-d can be deactivated. In this instance the immersion heater would not heat the nano-fluid within the deactivated heater module(s) 7a-d. The secondary fluid would then flow through the deactivated heater module(s) 7a-d without any, or at least limited, heat transfer taking place between the nano-fluid and the secondary fluid.

Alternatively, the control system 30 may reduce the current supplied to one or more of the immersion heaters within each heater module 7a-d to reduce the temperature the nano-fluid is heated to. This in turn means that less heat is transferred to the circulating secondary fluid.

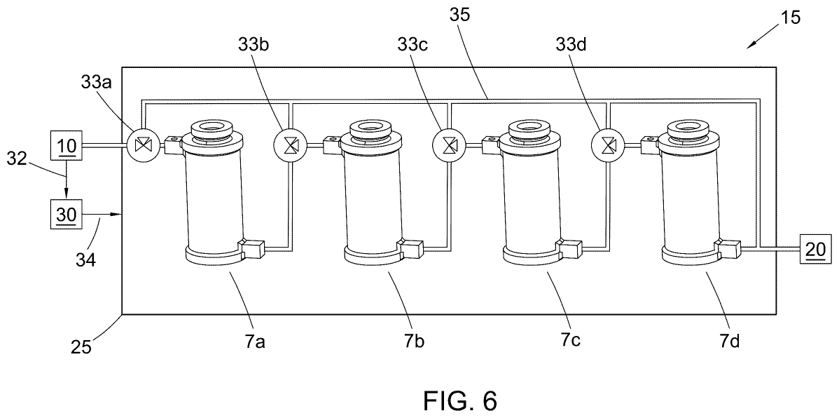

In yet a further alternative, and as depicted in FIG. 6, the boiler comprises a valve 33a-d preceding the inlet 2 of each of the heating modules 7a-d. Each of the valves 33a-d are three way valves to allow the secondary fluid to flow from the source of secondary fluid 10 or the preceding heating module 7a-c either to the next heating module 7b-d, or to a bypass line 35. This allows the control system 30 to select which of the heating modules 7a-d are operational. The control system 30 is configured to alternate the heating modules 7a-d which are bypassed so that the heating of the secondary fluid carried out by each heating module 7a-d is equal.

For example, the control system 30 may configure the three-way valve 33c between the second and third heat exchanger 7b, 7c to prevent flow of the secondary fluid to the third heating module 7c, and divert the secondary fluid leaving the outlet 3 of the second heating module 33b to the bypass line 35. The second valve 33b would then be configured to direct secondary fluid from the first heating module 7a to the second heating module 7b, and the fourth valve 33d would be configured to direct secondary fluid in the bypass line 35 to the inlet 2 of the fourth heating module 7d. This means that the secondary fluid is bypassing the third heating module 7c and therefore the heat being transferred to the secondary fluid circulating through the boiler is reduced accordingly.

In operation, the user may adjust the settings of the radiators within the heating circuit 20 in the well-known manner. In the case of one or more of the radiators being turned off, none of the heated secondary fluid within the heating circuit 20 may be pumped to the deactivated radiators. In the case the heat output being reduced at one or more of the radiators on the heating circuit 20, less secondary fluid may be pumped to those radiators, or the radiators may be configured in some other way to reduce the amount of heat extracted from the secondary fluid. In each case, the overall heat extracted from the secondary fluid by the heating circuit 20 is reduced and therefore the temperature of the secondary fluid returning to the source of secondary fluid 10 is increased compared to a heating system 15 where all of the radiators are fully operational.

The source of secondary fluid 10 comprises a return temperature sensor which measures the temperature of the secondary fluid 10 returning from the heating circuit 20. The heating circuit 20 comprises a supply temperature sensor to ensure that the desired flow temperature to the hearing circuit 20 is being met and a flow sensor to determine the flow rate of the fluid entering the heating circuit 20.

The control system 30 receives the return temperature of the secondary fluid as an input 32 from the return temperature sensor, the supply temperature of the secondary fluid entering the heating circuit 20 from the supply temperature sensor and the flow rate of the fluid entering the heating circuit from the flow sensor. The control system 30 then determines the temperature drop (deltaT) of the secondary fluid and based on this, the flow rate of the secondary fluid and the temperature set point input determined by a thermostat (not shown) in communication with the control system 30, determines the heating demand of the boiler 25.

This heating demand is then used by the control system 30 to determine one or more of: the number of heating modules 7a-d within the boiler 25 which are activated; the heat supplied to each nano-fluid by the immersion heaters present in each hearing module 7a-d; or the configuration of the one or more valves 33a-c used to bypass one or more of the heating modules 7a-d. Output signal 34 is provided accordingly.

For example, if the heating demand is set to 50% of the overall capacity, the control system 30 may send a signal 34 to deactivate two of the four heater modules within the boiler 15. Alternatively, the control system 30 may send a signal to reduce the current supply to each immersion heater such that temperature each nano-fluid is heated to is reduced by 50%. As further alternative, the control system 30 may configure the valves 33a-d to prevent flow to two of the four heater modules 7a-d. Increasing the number of heater modules 7a-d within the boiler 25 would therefore provide additional fidelity in the range of power demands that can be met.

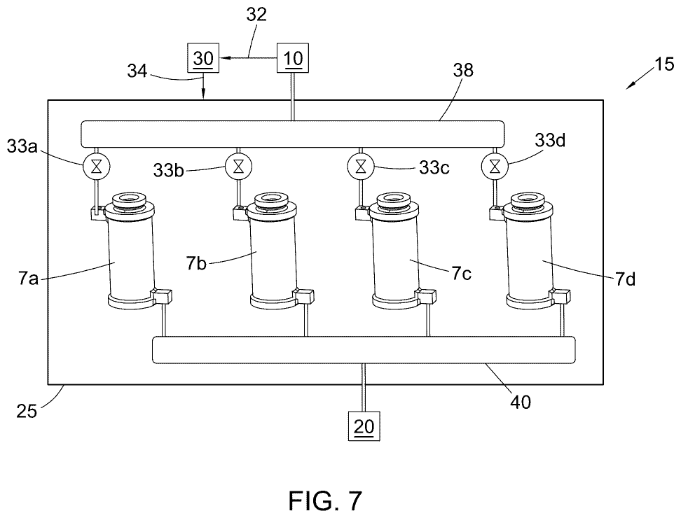

FIG. 7 shows a further embodiment of the heating system 15 comprising a boiler 25, a source of secondary fluid 10 and a heating circuit 20. In this embodiment, the boiler 25 comprises four heater modules 7a-d, as described in relation to FIGS. 1 to 3, connected in parallel. The boiler 25 comprises an inlet manifold 38 and an outlet manifold 40. The source of secondary fluid 10 supplied the inlet manifold 38 which then splits into a plurality of pipes each connected to a separate inlet 2 of the heater modules 7a-d. The outlet 3 of each heater module 7a-d feeds a pipe which supplies the heated secondary fluid to the outlet manifold 40 which then feeds the heating circuit 20.

The boiler further comprises a valve 33a-d controlling the flow of secondary fluid from the inlet manifold 38 to each of the heating modules 7a-d. In this embodiment, each of the valves 33a-d are two-way valves which may be configured to prevent flow of the secondary fluid to the one or more heating modules 7a-d within the boiler 25.

In operation, the secondary fluid is supplied to the inlet manifold 38 which supplies each heater module 7a-d directly, as opposed to in the embodiment of FIG. 5 where the secondary fluid is supplied to the first heater module 7a only by the source 10. Each of the heater module(s) comprise an immersion heater to heat the nano-fluid within the inner reservoir 12, which then heats the secondary fluid within the thermal jacket 14. The heated secondary fluid then flows directly to the heating circuit 20 via the outlets 3 of each heater module 7a-d.

As with the embodiment depicted in FIGS. 5 and 6, the heating system 15 shown in FIG. 7 comprises a control system 30 which operates the same way as the control system described in connection with FIGS. 5 and 6 above in that a heating demand for the boiler 25 is determined based on the return and supply temperature and the flow rate of the secondary fluid and the temperature set point of the heating system 15. The control system 30 will then deactivate one or more of the heater modules 7a-d, or reduce the current supply to one or more of the immersion heaters within the heating modules 7a-d. Alternatively, or in addition, the control system 30 may close the valve 33a-d preventing flow of secondary fluid to one or more of the heating modules 7a-d, and direct the flow of secondary fluid to the other heater modules 7a-d to adjust the overall capacity of the boiler.

In each of the boiler arrangements 15 shown in FIGS. 4 to 7, the heater module(s) 7a-d are arranged in a vertical orientation whereby the central axis of the cylindrical first volume 12 of the or each heater module is vertical with respect to the arrangement of the overall boiler 15. In the case of the boilers depicted in FIGS. 4 to 6, the orientation of each heater module 7a-d is substantially perpendicular with respect to the overall flow direction of the secondary circulating fluid within the circuit. In the boiler 15 shown in FIG. 7 the orientation of each heater module 7a-d is substantially parallel with respect to the overall flow direction of the secondary circulating fluid within the boiler 15.

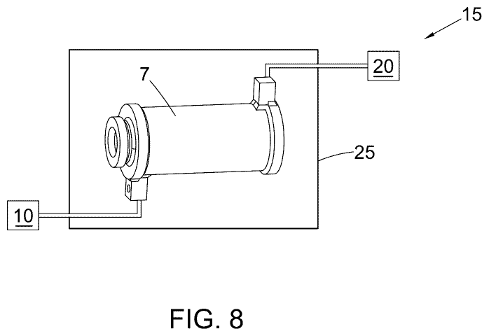

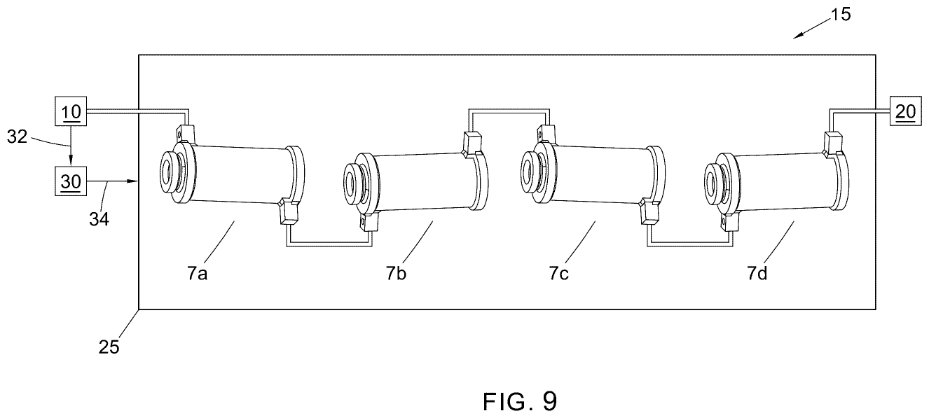

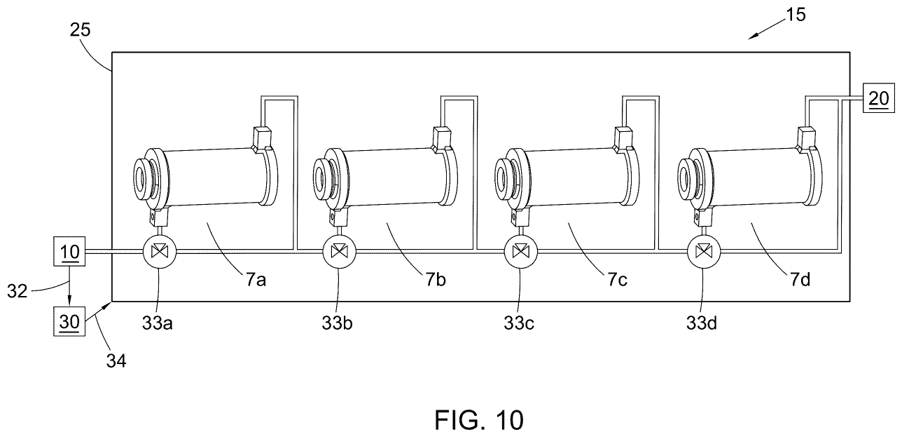

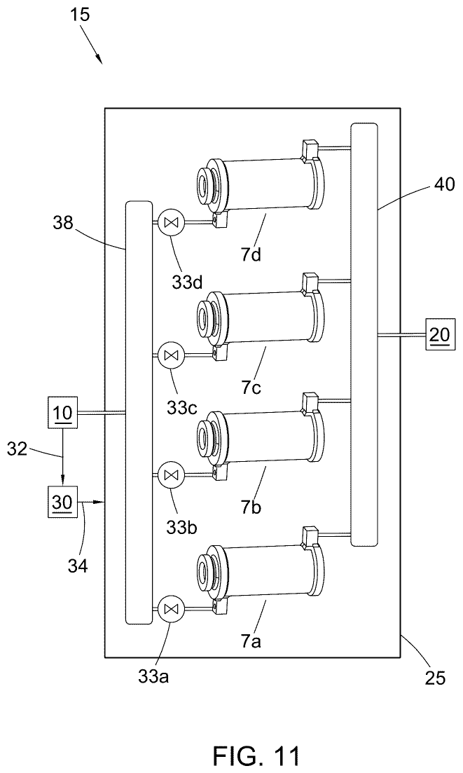

Each of the boiler arrangements 15 depicted in FIGS. 8 to 11 correspond to the boilers 15 shown in FIGS. 4 to 7, but each of the heater modules are arranged in a horizontal arrangement whereby the central axis of the cylindrical first volume 12 of the heater module is horizontal with respect to the arrangement of the overall boiler 15 and is substantially parallel with respect to the overall flow direction of the secondary circulating fluid within the boiler 15. The remaining features of the boilers 15 depicted in each of FIGS. 8 to 11 operate in the same manner as for the boilers shown in FIGS. 4 to 7.

1. A heater module comprising:
a heat exchanger including:
a first volume comprising a nano-fluid; and
a second volume surrounding the first volume and in thermal communication with the first volume for a secondary fluid to circulate within, wherein the second volume comprises a secondary fluid inlet and a secondary fluid outlet;
the heating module further comprising an electric heating element located within the first volume;
wherein in use the electric heating element is configured to heat the nano-fluid within the first volume, and
wherein the heated nano-fluid is configured to heat the secondary fluid circulating within the second volume by conduction and/or convection.

2. The heater module according to claim 1, wherein, in use, the electric heating element is configured to heat the nano-fluid to a temperature of 300° C. or less, optionally of 250° C. or less.

3. The heater module according to claim 1, wherein, in use, the secondary fluid circulating within the second volume is supplied to a heating circuit at a temperature in the range of 40° C. to 80° C.

4. The heater module according to claim 1, wherein the heater module is for use in a boiler.

5. The heater module according to claim 1, wherein the second volume is a thermal jacket which completely surrounds the first volume.

6. The heater module according to claim 1, wherein the secondary fluid comprises water, or wherein the nano-fluid is a first nano-fluid, and the secondary fluid is a second nano-fluid.

7. (canceled)

8. The heater module according to claim 1, wherein the heater module comprises a temperature sensor configured to measure the temperature of the nano-fluid within the first volume.

9. The heater module according to claim 8, wherein the heater module comprises a control system configured to control the electric heating element to maintain the temperature of the nano-fluid in a pre-defined temperature range.

10. A method of heating a circulating secondary fluid using a heater module, the heater module comprising:
a heat exchanger including:
a first volume comprising a nano-fluid; and
a second volume surrounding the first volume and in thermal communication with the first volume for a secondary fluid to circulate within, wherein the second volume comprises a secondary fluid inlet and a secondary fluid outlet; and
the heating modules further comprising an electric heating element located within the first volume;
the method comprising:
heating the nano-fluid within the first volume using the electric heating element; and
circulating the secondary fluid within the second volume such that the heat from the nano-fluid is transferred to the secondary fluid by conduction and/or convection.

11. The method according to claim 10, further comprising:
monitoring the temperature of nano-fluid using a temperature sensor; and
maintaining the temperature of the nano-fluid within a predefined temperature range using the electric heating element.

12. A boiler for use in a heating system comprising:
one or more of heater modules, wherein each heater module comprises:
a heat exchanger including:
a first volume comprising a nano-fluid; and
a second volume surrounding the first volume and in thermal communication with the first volume for a secondary fluid to circulate within, wherein the second volume comprises a secondary fluid inlet and a secondary fluid outlet; and
the heater module further comprising an electric heating element located within the first volume;
wherein in use the electric heating element is configured to heat the nano-fluid within the first volume, and
wherein the heated nano-fluid is configured to heat the secondary fluid circulating within the second volume by conduction and/or convection.

13. The boiler according to claim 12, wherein, in use, the electric heating element is configured to heat the nano-fluid to a temperature of 300° C. or less, optionally of 250° C. or less.

14. The boiler according to claim 12, wherein, in use, the boiler is configured to provide the secondary fluid to a heating circuit at a temperature in the range of 40° C. to 80° C.

15. The boiler according to claim 12, wherein the boiler comprises a plurality of heater modules, and
wherein the boiler comprises a controller configured to set a heating output of the boiler by selecting one or more of the plurality of heater modules to heat the circulating secondary fluid.

16. The boiler according to claim 15, wherein each of the plurality of heater modules are connected in series, or wherein each of the plurality of heater modules are connected in parallel.

17. (canceled)

18. The boiler according to claim 15, wherein the controller is configured to set the heating output of the boiler by selecting the number of heater modules where the electric heating element is active, or wherein the controller is configured to set the heating output of the boiler by controlling a current supplied to the electric heating element in each of the plurality of heater modules.

19. (canceled)

20. The boiler according to claim 15, wherein the boiler further comprises one or more valves configured to control the flow of the secondary fluid between the plurality of heater modules, optionally wherein the controller is configured to set the heating output of the boiler by controlling the one or more valves to prevent flow of secondary fluid to one or more of the plurality of heater modules.

21. (canceled)

22. A method of controlling a heating output of a boiler for use in a heating system, the boiler comprising:
a plurality of heater modules, wherein each heater module comprises:
a heat exchanger including:
a first volume comprising a nano-fluid; and
a second volume surrounding the first volume and in thermal communication with the first volume for a secondary fluid to circulate within, wherein the second volume comprises a secondary fluid inlet and a secondary fluid outlet; and
the heater module further comprising an electric heating element located within the first volume;
wherein in use the electric heating element is configured to heat the nano-fluid within the first volume, and
wherein the heated nano-fluid is configured to heat the secondary fluid circulating within the second volume by conduction and/or convection;
wherein the method comprises setting, with a controller, a heating output of the boiler by selecting one or more of the plurality of heater modules to heat the circulating secondary fluid.

23. The method according to claim 22, comprising setting the heating output of the boiler by selecting the number of heater modules where the electric heating element is active, or comprising setting the heating output of the boiler by controlling a current supplied to the electric heating element in each of the plurality of heater modules.

24. (canceled)

25. The method according to claim 22, wherein the boiler further comprises one or more valves configured to control the flow of the secondary fluid between the plurality of heater modules, and wherein the method further comprises setting the heating output of the boiler by controlling the one or more valves to prevent flow of secondary fluid to one or more of the plurality of heater modules.

26. (canceled)

27. (canceled)
